(19) United States
(12) Patent Application Publication
(10) Pub. No.: US 2014/0280796 A1
(43) Pub. Date: Sep. 18, 2014

(54) SYSTEMS AND METHODS FOR PROVIDING A DISTRIBUTED SERVICE CONFIGURATION FRAMEWORK

(71) Applicant: William Pijewski, San Francisco, CA (US)

(72) Inventor: William Pijewski, San Francisco, CA (US)

(73) Assignee: Joyent, Inc., San Francisco, CA (US)

(21) Appl. No.: 14/195,825

(22) Filed: Mar. 3, 2014

Related U.S. Application Data
(60) Provisional application No. 61/785,646, filed on Mar. 14, 2013.

(51) Int. Cl. H04L 12/24

(52) U.S. Cl. CPC H04L 41/0886
USPC 709/220

(57) ABSTRACT

Systems and method for providing a distributed service configuration framework are provided herein. In some instances, methods may include facilitating an application within a cloud computing system, facilitating a plurality of services of the application, the plurality of services being of a same type, deploying an instance within a given service, and automatically configuring the instance using configuration information obtained by a configuration agent, the configuration agent being associated with the instance. Each instance is associated with its own configuration agent.

### CROSS REFERENCE TO RELATED APPLICATIONS

This application claims the priority benefit of U.S. Provisional Application Ser. No. 61/785,646, filed on Mar. 14, 2013, titled “SYSTEMS AND METHODS FOR PROVIDING A DISTRIBUTED SERVICE CONFIGURATION FRAMEWORK”, which is hereby incorporated by reference herein in its entirety including all reference cited therein.

### FIELD OF THE PRESENT TECHNOLOGY

The present technology relates generally to cloud computing. More specifically, but not by way of limitation, the present technology includes systems and methods for providing a distributed configuration framework within a cloud computing environment. This framework may be utilized by system operators or cloud customers to distribute updates to applications, services, and instances based upon a chain of dependency therebetween.

### BACKGROUND

Various methods and systems for providing multitenant computing systems, such as cloud computing, have been attempted. In general, a cloud-based computing environment is a resource that typically combines the computational power of a large model of processors and/or that combines the storage capacity of a large model of computer memories or storage devices. For example, systems that provide a cloud resource may be utilized exclusively by their owners; or such systems may be accessible to outside users who deploy applications within the computing infrastructure to obtain the benefit of large computational or storage resources.

The cloud may be formed, for example, by a network of servers with each server (or at least a plurality thereof) providing processor and/or storage resources. These servers may manage workloads provided by multiple users (e.g., cloud resource consumers or other users). Typically, each user places workload demands upon the cloud that vary in real-time, sometimes dramatically. The nature and extent of these variations typically depend on the type of business associated with the user.

### SUMMARY

In some embodiments, the present technology is directed to a method, comprising: (a) creating a zone within cloud computing system, the zone comprising an application, a service, and an instance that are in dependent relationship with one another; (b) provisioning an agent for the instance of the zone, the agent using a services application programming interface (SAPI) to relay to the instance, configuration details for the zone received from a management node of the cloud computing system; and (c) automatically configuring the zone by providing configuration information to the agent.

In some embodiments, the present technology is directed to a cloud computing system, comprising: (a) a processor; and (b) a memory for storing executable instructions, the processor executing the instructions to: (i) create a zone within cloud computing system, the zone comprising an application, a service, and an instance that are in dependent relationship with one another; (ii) provision an agent for the instance of the zone, the agent using a services application programming interface (SAPI) to relay to the instance, configuration details for the zone received from a management node of the cloud computing system; and (iii) automatically configure the zone by providing configuration information to the agent.

In some embodiments, the present technology is directed to a method, comprising: (a) facilitating an application within a cloud computing system; (b) facilitating a plurality of services of the application, the plurality of services being of a same type; (c) deploying an instance within a given service; and (d) automatically configuring the instance using configuration information obtained by a configuration agent, the configuration agent being associated with the instance, wherein each instance is associated with its own configuration agent.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a block diagram of an exemplary cloud computing environment in which embodiments of the present technology may be practiced;

FIG. 2 is a block diagram of an object store (e.g., zone);

FIG. 3 is a block diagram of an application, service, and instance that are executing a portion of an object store; and

FIG. 4 is a block diagram of an application that is associated with a plurality of similar services that are provided for different objects in a zone;

FIG. 5A is a flowchart of an exemplary method for providing a distributed service configuration framework;

FIG. 5B is a flowchart of another exemplary method for providing a distributed service configuration framework; and

FIG. 6 illustrates an exemplary computing system that may be used to implement embodiments according to the present technology.

### DESCRIPTION OF EXEMPLARY EMBODIMENTS

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the present technology. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

FIG. 1 is a block diagram of an exemplary cloud computing environment, hereinafter “cloud 100,” in which embodiments of the present technology may be practiced. The present technology contemplates building a distributed configuration framework for deploying and managing multiple services. This framework provides operators with a means to deploy software and manage that software's configuration that operate within the cloud 100. A management node 135 may be utilized to track applications 105, services 110, and instances (example instance 115 is shown) which are running within the cloud 100. The management node 135 tracks information that includes not only what services are deployed, but the location of each service, as well as configuration details regarding the service. The “location” of a service references the location of a data that is being operated on within an object store, such as object store 100A. It is noteworthy that the object store 100A may include, for example, a local or distributed object store that maintains contiguous blobs, blocks, or chunks of data. A tenant 100B or customer is allocated space in the object store 100A according to their needs. The object store 100A may service hundreds or thousands of tenants. The tenant may be accessed using a client terminal 100C, such as an end user computing system.

It is noteworthy to mention that the object store 100A may be logically separated into zones that can include various objects. A zone can manage a portion of the object store 100A. For example, a zone may be dedicated to a tenant, such as tenant 100B.

It will be understood that in some instances the objects stored in the object store 100A are complete objects, such as files or other similar data structures. Moreover, applications and services are used to implement the object store 100A.

The management node 135 may monitor instances of services executed against tenants in the object store 100A using an agent 125.

Each datacenter (e.g., object store) has a single SAPI zone. That SAPI zone is stateless and can write objects into its datacenter database. In addition to storing its objects in the datacenter, the SAPI zone also communicates with a virtual machine application programming interfaces (VMAPI) to provision zones and network application programming interfaces (NAPI) to reserve network interface controllers (NICs) and lookup network universally unique identifiers (UUIDs) that are indicative of unique zones in the datacenter. Again, these zones may be dedicated to a specific tenant or customer.

It is noteworthy that an application 105 may include a plurality of services, which are of the same type. Each service 110 may include an instance 115 of service 110. For example, the application may include a data center application. A service of this application may include a database related service, while an instance may include the particular virtual machine that runs the application. It will be understood that an instance is used to directly manage object store tenant data. Advantageously, data need not be moved in and out of the object store 100A in order to execute operations against the tenant data.

FIG. 2 illustrates a tenant that has been allocated a sector of the object store or zone. For brevity, only a portion of the tenant's objects are illustrated, such as objects A-D. It will be understood that the tenant may have more or fewer objects stored in the object store. FIG. 3 illustrates the execution of an application 205, an associated service 210, and an instance 215 on a selected object, such as Object A. It will be understood that the application, service, and instance may be executed against a plurality of objects for the tenant. It will also be further understood that many applications, services, and instances may be executed against the object(s) of the tenant. Again, the application(s), service(s), and instance(s) are executed directly on Object A to reduce or eliminate the need to move objects in and out of the object store for processing.

Returning to FIG. 1, a centralized configuration store 120 may be used as a repository for maintaining configuration information for applications, services, and instances. Configuration updates may also be stored in the configuration store 120 and disseminated to services via the management node 135. Configuration information may include various zone properties, which will be described in greater detail below.

It will be understood that within each instance there is an agent 125 that queries the management node 135 for configurations. The agent 125 also applies configuration updates to each instance running locally.

The system allows operators to work with higher-level abstractions for deploying services, rather than situations where operators would deploy and configure machines individually, either for tenants, objects, or combinations thereof. Instead the operator may deploy many virtual machines (e.g., instances) and the instances can be configured from a central location. For example, the operator may deploy multiple database instances that coordinate data replication and backup. The agent 125 may retrieve configuration details that instruct the service to replicate files. Those details are retrieved from the management node 135, and are generated first from the instance 115, then from the service 110, and finally from the application 105. This chain of dependency and relatedness allows the operators to publish changes to the instances without having to directly configure each instance. While the operator is able to publish configuration changes directly to the management node 135, the agent 125 is responsible for applying those changes to each instance. This model allows the operator a scalable and flexible way of managing a heterogenous fleet of instances.

Again, the agent 125 may be configured to examine configurations for the application 105, the service 110, and the instance 115, to determine which configuration is applied at the application level only, and which configurations are inherited from the service 110 by the instance 115. The operator may make changes to configurations at the application level and those changes are propagated to each of the services, and also to each instance running on a service. The agent 125 may receive these configurations directly from the management node 135.

The cloud may implement a services application programming interface (SAPI), which provides features such as automatic discovery of object stores, dynamic configuration of object stores, and an API for a user portal. In sum, this interface allows users to configure, deploy, and upgrade applications using a set of loosely-coupled, federated services. In some embodiments, SAPI may include an underlying API and the agent 125 as mentioned above. Again, an application may comprise one or more services, and each service may comprise one or more instances. Moreover, instances may represent actual object store zones, and such zones inherit zone parameters and metadata from their associated applications and services. The object store zone may include one or more objects, such as objects A-D of FIG. 2, just as an example.

Also, the application, service, and instance information may be used by the compute application of a virtual operating system container that is placed onto an object store. The agent 125 may control the operation of an individual zone operating on an object store. Many zones and agents may be provisioned and operate at the same time.

Each application, service, and instance may include three sets of properties. (1) “params” may comprise zone parameters like a zone's RAM size, disk quota, and so forth (e.g., computational resource attributes). These parameters are evaluated when a zone is provisioned; and (2) “metadata”, which defines metadata available to the agent 125. These metadata keys and values form the input of a script template in a configuration manifest. As these values are updated, the agent 125 may rewrite any configuration and make reference to changed metadata values. Yet another property (3) comprises “manifests” that define a set of configuration manifests that are indexed by name to facilitate inheriting manifests from parent objects. The agent 125 looks at the manifests associated with the parent application and the parent service, as well as the particular instance, to determine the full set of manifests which comprise an instance's configuration. These manifests are commonly used to provide instructions to the programs running inside an instance, but their free-form nature allows operators to define any manner of configuration state.

Provided below is an example implementation of the SAPI described above. In an example use, an application may have these properties:

```
        {
        “params”: {
            “ram”: 256,
            “quota”: 10
        },
        “metadata”: {
            “MORAY”: “1.moray.manta.joyent.us”
        },
        “manifests”: {
            “registrar”: “76e51922-808b-11e2-af4e-bb62bca39c7f”
        }
}
```

A service associated with the application may have these properties:

```
        {
        “params”: {
            “quota”: 0
        },
        “metadata”: {
            “NGINX_WORKERS”: 8
        },
        “manifests”: {
            “mako”: “9968efc8-808b-11e2-ae99-9fb2d8f3fdff”
    }
}
```

An instances associated with both the service and application may have these properties:

```
    {
        “params”: {
            “delegate_dataset”: true
        },
        “metadata”: {
            “DATA_DIR”: “/manta”,
            “MORAY”: “2.moray.manta.joyent.us”
        },
        “manifests”: {
            “mako”: “cc3f2584-808b-11e2-85de-1796a075e6f7”,
            “minnow”: “c58f9dda-808c-11e2-b818-6ba0930bad61”
        }
}
```

A resulting zone would have zone properties which can be passed to a virtual machine that is executed for the tenant. These properties would include:

```
      {
        “ram”: 256,
        “quota”: 0,
    “delegate_dataset”: true
}
```

The zone would also have metadata that includes:

```
      {
        “NGINX_WORKERS”: 8,
        “DATA_DIR”: “/manta”,
    “MORAY”: “2.moray.manta.joyent.us”
}
```

The zone may also use the following configuration manifests:

```
      {
        “registrar”: “76e51922-808b-11e2-af4e-bb62bca39c7f”,
        “mako”: cc3f2584-808b-11e2-85de-1796a075e6f7”,
    “minnow”: “c58f9dda-808c-11e2-b818-6ba0930bad61”
}
```

Each zone deployed with an SAPI contains an agent 125 that is responsible for maintaining configuration inside that zone. The config-agent 125 queries SAPI directly to determine which files to write and where to write them. The agent uses objects called configuration manifests; those objects describe the contents, location, and semantics of configuration files for a zone.

An example of a configuration manifest is provided below:

```
{
    “path”: “/opt/smartdc/minnow/etc/config.json”
    “post_cmd”: “svcadm refresh minnow”,
    “template”: {
        “moray”: {
            “bucket”: {
                “name”: “manta_storage”,
                “index”: {
                    “hostname”: { “type”: “string” },
                    “availableMB”: { “type”: “number” },
                    “percentUsed”: { “type”: “number” },
                    “server_uuid”: { “type”: “string” },
                    “timestamp”: { “type”: “number” },
                    “zone_uuid”: { “type”: “string” }
                }
            },
            “connectTimeout”: 200,
            “retry”: {
                “retries”: 2,
                “minTimeout”: 500
            },
            “host”: “{{MORAY}}”,
            “port”: 2020
        },
    “objectRoot”: “{{DATA_DIR}}”,
    “zone_uuid”: “{{ZONE_UUID}}”,
    “interval”: 5000
}
}
```

Combined with the metadata from the above example, the config-agent (e.g. agent 125 of FIG. 1) would write this file into/opt/smartdc/minnow/etc/config.json and then refresh the minnow SMF service, as shown below:

```
  {
    “moray” {
        “bucket”: {
            “name”: “manta_storage”,
            “index”: {
                “hostname”: { “type”: “string” },
                “availableMB”: { “type”: “number” },
                “percentUsed”: { “type”: “number” },
                “server_uuid”: { “type”: “string” },
                “timestamp”: { “type”: “number” },
                “zone_uuid”: { “type”: “string” }
                }
            },
        “connectTimeout”: 200,
        “retry”: {
            “retries”: 2,
            “minTimeout”: 500
        },
        “host”: “2.moray.manta.joyent.us”,
        “port”: 2020
    },
    “objectRoot”: “/manta”,
    “zone_uuid”: “ed23ee9a-808d-11e2-9046-db0663155996”,
    “interval”: 5000
}
```

The {{ZONE_UUID}} variable above is rendered with the zone's UUID. SAPI provides certain variables like ZONE_UUID, SERVER_UUID, etc. based on the zone's attributes.

It is noteworthy that creating applications and services has no effect on running instances. When an instance is created, a zone is provisioned using the above information from its associated application, service, and instance. Stated otherwise, applications and services may be defined as separate from the objects that the applications and services are to be executed against. Thus, an application or service may be thought of abstractly as an instance template. Advantageously, when the user requests the provision of a new instance, the parent application and service's configuration provide a template for the instance's configuration.

In some embodiments, the agent 125 of a zone may be tasked with maintaining configuration inside that zone. The agent 125 queries SAPI directly to determine which files to write and where to write them within the object store.

The agent 125 uses objects called configuration manifests; those objects describe the contents, location, and semantics of configuration files for a zone. Those manifests contain the contents of configuration files which are rendered using the metadata from the associated application, service, and instance. The management module may be configured to execute operations such as manifest creation, manifest list (where a list of available manifests is obtained), GET manifest (where a specific manifest is obtained), delete manifest, Similar functionalities for instances, such as list, get, delete, updated, GET payload, and other functionalities can be implemented. Services and applications may also be controlled or managed with similar functionalities.

By way of example, a CreateApplication operation would allow the system to create a new application. To be sure, an application is provided with a name and an owner UUID, which associates the application with a tenant or zone. An example of a routine for creating an application is provided below:

```
  POST /applications -d ‘{
    “name”: “sdc”,
    “owner_uuid”: “930896af-bf8c-48d4-885c-6573a94b1853”,
    “params” {
        “delegate_dataset”: true
}
}
```

A get application list operation may be implemented as follows:

```
  GET/applications?name=manta
[
    {
    “uuid”: “14160e92-5533-11e2-86a2-9f78cf99260d”,
        “name”: “sdc”,
    “owner_uuid”: “1959d690-5533-11e2-8bee-1b98757172d1”,
    “params”: {
        “ram”: 1024,
        “quota”: 100
    },
    “metadata”: {
        “NAMESERVERS”: [ “10.99.99.20”, “10.99.99.21” ],
        “REGION”: “sf”
    },
    “manifests”: {
    “dns_client”: “e0ebe2ac-8a30-49e2-b1a6-4cc9d763f3e1”
    }
    }
]
```

Applications can be retrieved by SAPI using the UUID assigned above. Various properties of an application can also be updated using an update function. For example, a domain may be changed from “example.domain,dev” to “example2.domain.dev”.

Again, these examples describe operations that can be executed for applications in a zone, but operations can also be executed for services and instances within a zone. For example, the SAPI can be used to obtain the payload for an instance running in a zone:

```
  GET instances/18e7dbc9-0f2b-421b-ba39-d1701c55a1f5/payload
    {
        “delegate_dataset”: true,
        “image_uuid”: “e32e839b-4955-4332-b489-65d70debfaa4”,
        “ram”: 2048,
        “owner_uuid”: “a6ef45d3-580d-49a2-adfa-0abb20579574”,
        “uuid”: “18e7dbc9-0f2b-421b-ba39-d1701c55a1f5”,
        “brand”: “joyent-minimal”,
        “server_uuid”: “44454c4c-4800-1034-804a-b2c04f354d31”,
        “customer_metadata”: {
            “ufds_admin_ip”: “ldaps://10.2.206.10”,
            “ufds_url”: “ldaps://10.2.206.10”,
            “service_port”: 80,
            ....
        }
}
```

While the above paragraphs provide examples of implementations of the present technology, one of ordinary skill in the art will appreciate that the examples are non-limiting and thus are adaptable to create other types of zones as needed.

FIG. 4 illustrates an application 405 that is deployed within an object store 400. This entity may be an object store or datacenter of a cloud computing system. The application 405 is associated with a plurality of services, such as service 410A and service 410B. In this instance, services 410A and 410B are database query services that are of the same type as one another. Each of the services includes an instance or virtual machine that performs the query services on objects in the zone 400. For example, instance 415 operates on Object A and instance 425 operates on Object N. Configuration agent 420 provides configuration information to its associated instance 415 and configuration agent 430 provides configuration information to its associated instance 425. Rather than maintaining each of the application, service, and instance groupings individually, the configuration information is pushed to the agents who control and monitor the configurations of the instances. In some instances, instances may inherit some configuration information from its service, while the service may in turn inherit some configuration information from the application. Some configuration information may not be inherited but is provided to the instance by the agent directly.

FIG. 5A is a flowchart of an exemplary method for providing a distributed service configuration framework. The method includes creating 505 a zone within cloud computing system, the zone comprising an application, a service, and an instance that are in dependent relationship with one another. As mentioned above, the application may be associated with a plurality of services of similar type, and each service is provisioned with an instance. The instance is in turn associated with an agent that provides the instance with its configuration information that controls how the instance operates on objects within the zone.

Next, the method includes provisioning 510 an agent for the instance of the zone. The agent uses a services application programming interface (SAPI) to relay to the instance, configuration details for the zone received from a management node of the cloud computing system. Next, the method includes automatically configuring 515 the zone by providing configuration information to the agent.

FIG. 5B is a flowchart of an exemplary method for providing a distributed service configuration framework. The method includes facilitating 520 an application within a cloud computing system. For example, the application may include a database management application. Next, the method includes facilitating 525 a plurality of services of the application, the plurality of services being of a same type. By way of example, the services may include a database cleanup function that consolidates and deletes old data in an object store.

In some instances the method includes deploying 530 an instance within a given service. For example, this may include executing a virtual machine for each service. The method also includes automatically configuring 535 the instance using configuration information obtained by a configuration agent. Again, the configuration agent is associated with the instance.

FIG. 6 illustrates an exemplary computing system 600 that may be used to implement an embodiment of the present systems and methods. The system 600 of FIG. 6 may be implemented in the contexts of the likes of computing systems, networks, servers, or combinations thereof. The computing system 600 of FIG. 6 includes one or more processors 610 and main memory 620. Main memory 620 stores, in part, instructions and data for execution by processor 610. Main memory 620 may store the executable code when in operation. The system 600 of FIG. 6 further includes a mass storage device 630, portable storage device 640, output devices 650, user input devices 660, a display system 670, and peripheral devices 680.

The components shown in FIG. 6 are depicted as being connected via a single bus 690. The components may be connected through one or more data transport means. Processor unit 610 and main memory 620 may be connected via a local microprocessor bus, and the mass storage device 630, peripheral device(s) 680, portable storage device 640, and display system 670 may be connected via one or more input/output (I/O) buses.

Mass storage device 630, which may be implemented with a magnetic disk drive or an optical disk drive, is a non-volatile storage device for storing data and instructions for use by processor unit 610. Mass storage device 630 may store the system software for implementing embodiments of the present technology for purposes of loading that software into main memory 620.

Portable storage device 640 operates in conjunction with a portable non-volatile storage medium, such as a floppy disk, compact disk, digital video disc, or USB storage device, to input and output data and code to and from the computer system 600 of FIG. 6. The system software for implementing embodiments of the present technology may be stored on such a portable medium and input to the computer system 600 via the portable storage device 640.

User input devices 660 provide a portion of a user interface. User input devices 660 may include an alphanumeric keypad, such as a keyboard, for inputting alpha-numeric and other information, or a pointing device, such as a mouse, a trackball, stylus, or cursor direction keys. Additional user input devices 660 may comprise, but are not limited to, devices such as speech recognition systems, facial recognition systems, motion-based input systems, gesture-based systems, and so forth. For example, user input devices 660 may include a touchscreen. Additionally, the system 600 as shown in FIG. 6 includes output devices 650. Suitable output devices include speakers, printers, network interfaces, and monitors.

Display system 670 may include a liquid crystal display (LCD) or other suitable display device. Display system 670 receives textual and graphical information, and processes the information for output to the display device.

Peripherals device(s) 680 may include any type of computer support device to add additional functionality to the computer system. Peripheral device(s) 680 may include a modem or a router.

The components provided in the computer system 600 of FIG. 6 are those typically found in computer systems that may be suitable for use with embodiments of the present technology and are intended to represent a broad category of such computer components that are well known in the art. Thus, the computer system 600 of FIG. 6 may be a personal computer, hand held computing system, telephone, mobile computing system, workstation, server, minicomputer, mainframe computer, or any other computing system. The computer may also include different bus configurations, networked platforms, multi-processor platforms, etc. Various operating systems may be used including Unix, Linux, Windows, Mac OS, Palm OS, Android, iOS (known as iPhone OS before June 2010), QNX, and other suitable operating systems.

It is noteworthy that any hardware platform suitable for performing the processing described herein is suitable for use with the systems and methods provided herein. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a CD-ROM disk, digital video disk (DVD), any other optical storage medium, RAM, PROM, EPROM, a FLASHEPROM, any other memory chip or cartridge.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be coupled with the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A method, comprising:
creating a zone within cloud computing system, the zone comprising an application, a service, and an instance that are in dependent relationship with one another;
provisioning an agent for the instance of the zone, the agent using a services application programming interface (SAPI) to relay to the instance, configuration details for the zone received from a management node of the cloud computing system; and
automatically configuring the zone by providing configuration information to the agent.

2. The method according to claim 1, wherein the service is one of a plurality of services for the zone, the plurality of services being of the same type.

3. The method according to claim 2, wherein each of the plurality of services includes an instance and an agent, wherein each agent is provided with the configuration information for the zone.

4. The method according to claim 1, further comprising providing the agent with updated configuration information, wherein the agent provides the updated configuration information to the instance.

5. The method according to claim 1, further comprising a configuration store that stores the configuration information, the configuration store being couplable to the management node of the cloud computing system.

6. The method according to claim 1, wherein the zone is included in an object store of the cloud computing system, and the instance comprises a virtual machine that operates directly on objects stored in the object store.

7. The method according to claim 1, wherein the configuration information is transmitted to the agent in the form of a configuration manifest.

8. The method according to claim 7, wherein the configuration manifest includes a script template that comprises metadata keys and values.

9. The method according to claim 1, wherein the application, service, and instances each include properties that comprise:
zone parameters that define computational resource attributes of the zone;
metadata keys and values that form input of a script template; and
a configuration manifest that includes the script template and an index of manifests that are to be inherited from a parent object.

10. A cloud computing system, comprising:
a processor; and
a memory for storing executable instructions, the processor executing the instructions to:
create a zone within an object store of the cloud computing system, the zone comprising an application, a service, and an instance that are in dependent relationship with one another;
provision an agent for the zone, the agent using a services application programming interface (SAPI) to relay to the instance, configuration details for the zone received from a management node of the cloud computing system; and
automatically configuring the zone by providing configuration information to the agent.

11. The system according to claim 10, wherein the service is one of a plurality of services for the zone, the plurality of services being of the same type.

12. The system according to claim 11, wherein each of the plurality of services includes an instance and an agent, wherein each agent is provided with the configuration information for the zone.

13. The system according to claim 10, wherein the instance inherits at least a portion of its configuration information from the service or the application.

14. The system according to claim 13, wherein the cloud computing system is further configured to provide the agent with updated configuration information using the SAPI, wherein the agent provides the updated configuration information to the instance.

15. The system according to claim 10, further comprising a configuration store that stores the configuration information, the configuration store being coupled to the management node of the cloud computing system.

16. The system according to claim 10, wherein the instance comprises a virtual machine that operates directly on objects stored in the object store.

17. The system according to claim 10, wherein the configuration information is transmitted to the agent using the SAPI in the form of a configuration manifest.

18. The system according to claim 17, wherein the configuration manifest includes a script template that comprises metadata keys and values.

19. The system according to claim 18, wherein the application, service, and instances each include properties that comprise:
zone parameters that define computational resource attributes of the zone;
metadata keys and values that form input of a script template; and
a configuration manifest that includes the script template and an index of manifests that are to be inherited from a parent object.

20. A method, comprising:
facilitating an application within a cloud computing system;
facilitating a plurality of services of the application, the plurality of services being of a same type;
deploying an instance within a given service; and
automatically configuring the instance using configuration information obtained by a configuration agent, the configuration agent being associated with the instance, wherein each instance is associated with its own configuration agent.
